(19) United States
(12) Patent Application Publication
(10) Pub. No.: US 2025/0139994 A1
(43) Pub. Date: May 1, 2025

(54) Method for Monitoring a State of a Driver of a Vehicle by a Camera in an Interior of the Vehicle, Computer-readable Medium, System and Vehicle

(71) Applicant: Bayerische Motoren Werke Aktiengesellschaft, Muenchen (DE)

(72) Inventors: Johannes Feldmaier, Ebersberg (DE); Simone Camberg, Muenchen (DE)

(21) Appl. No.: 18/834,959

(22) PCT Filed: Nov. 30, 2022
(86) PCT No.: PCT/EP2022/083785

§ 371 Date: Jul. 31, 2024

(30) Foreign Application Priority Data
Feb. 18, 2022 (DE) 10 2022 103 912.9

(51) Int. Cl. G06V 20/59; B60R 1/12

(52) U.S. Cl. CPC G06V 20/597; B60R 1/12; B60R 2001/1223

(57) ABSTRACT

A method of monitoring a state of a driver of a vehicle uses a camera in the interior of the vehicle. A viewing behavior of a driver of the vehicle is determined during an active driving situation using the camera. The method includes determining a target viewing sequence of the active driving situation, and determining an actual viewing sequence during the active driving situation depending on the viewing behavior of the driver of the vehicle. A change in the actual viewing sequence from the target viewing sequence during the active driving situation is determined. The method also includes determining the state of the driver as tired if the change in the actual viewing sequence from the target viewing sequence indicates that a time interval between at least two views of the actual viewing sequence exceeds a predetermined threshold value.

The present application is the U.S. national phase of PCT Application PCT/EP2022/083785 filed on Nov. 30, 2022, which claims priority of German patent application no. 10 2022 103 912.9 filed on Feb. 18, 2022, the entire contents of which are incorporated herein by reference.

### TECHNICAL FIELD

The disclosure relates generally to monitoring a state of a driver of a vehicle by means of a camera in an interior of the vehicle, and methods and apparatus therefor.

### BACKGROUND

Current vehicles can detect attention or tiredness of a driver of a vehicle. For example, it is known from the prior art to recognize the attention of the driver of the vehicle depending on a viewing direction of the driver. Furthermore, it is known from the prior art to estimate driver tiredness based on an eye condition. Driver monitoring camera systems arranged in the area of a steering wheel of the vehicle can be used for detection. Current methods for detecting driver attention and tiredness often fail. For example, eye condition is not a sure feature for detecting tiredness. Furthermore, a fixed gaze of the driver often leads to a false recognition of the driver as attentive.

There is a need to monitor a state of a driver of a vehicle more efficiently. In particular, there is a need to detect tiredness and/or attention of a driver of a vehicle more efficiently.

### SUMMARY

The above-described needs, as well as others, are addressed by at least some embodiments described herein. Advantageous embodiments and developments result from the claims, specification and drawings.

A first aspect is characterized by a method for monitoring a state of a driver of a vehicle by means of a camera in an interior of the vehicle. The method can be a computer-implemented method and/or a control device-implemented method. The state of a driver is preferably attentive and/or tired. The vehicle can be a motor vehicle. The camera can be an RGB camera.

The method includes determination of a viewing behavior of a driver of the vehicle during an active driving situation with the vehicle by means of the camera in the interior of the vehicle. The viewing behavior can include a viewing direction, a viewing duration, an eye condition, a viewing sequence, and/or a time interval between views of the viewing sequence. In addition or alternatively, the viewing behavior may depend on one or more available and/or currently active driver assistance systems. The active driving situation may include, for example, driving straight ahead on a road, such as a motorway or country road, and/or a driving maneuver, such as changing lanes, turning, overtaking, entering and exiting of entries, exits, intersections and/or roundabouts, parking, and other maneuvers. driving The method includes determination of a target viewing sequence of the active driving situation. The target viewing sequence is preferably a viewing sequence that has been determined using a driver's historical viewing behavior. In addition or alternatively, the target viewing sequence can be a predetermined reference viewing sequence of the active driving situation. For example, the predetermined reference viewing sequence may include a minimal sequence of views to be at least performed by a driver of the vehicle. Furthermore, the predetermined reference viewing sequence can be determined depending on the available and/or currently active driver assistance systems of the vehicle.

The method also includes the determination of an actual viewing sequence during the active driving situation depending on the viewing behavior of the driver of the vehicle. The actual viewing sequence is preferably a viewing sequence of the driver, which is determined during a current, active driving situation. The method also includes determination change in the actual viewing sequence from the target viewing sequence during the active driving situation. If the change in the actual from viewing sequence the target viewing sequence indicates that a time interval between at least two views of the actual viewing sequence exceeds a predetermined threshold value, the method determines the state of the driver as tired.

Advantageously, the method can efficiently monitor a state of a driver during an active driving situation. In detail, the method can detect more precisely whether the driver of the vehicle is tired by comparing the driver's viewing sequences.

According to an advantageous design, the camera can be integrated into the interior of the vehicle and enable an unobstructed view of a driver, in particular a driver's head, of the vehicle, and/or the camera can be integrated into an interior mirror of the vehicle. This enables the driver to be monitored efficiently. The integration of the camera into the interior mirror of the vehicle enables cost-effective and easy integration of the camera for monitoring the driver of the vehicle.

In accordance with a further, advantageous design, the target viewing sequence of the active driving situation can be determined depending on a navigation task along a navigation route of the vehicle, and/or the target viewing sequence of the active driving situation can be determined depending on an operating interaction of the driver with a driving-relevant operating component of the vehicle, and/or the target viewing sequence of the active driving situation can be determined depending on a driving event, and/or the target viewing sequence can be determined depending on a model of the surroundings of the vehicle. This enables the target viewing sequence to be determined efficiently depending on various parameters.

According to a further, advantageous design, the target viewing sequence can be a driver-specific target viewing sequence of the active driving situation, and the driver-specific target viewing sequence can preferably be learned within a predetermined time interval using a historical viewing behavior of the driver of the vehicle in the active driving situation. This enables a driver-specific viewing sequence to be determined efficiently.

According to a further, advantageous design, the target viewing sequence can include a sequence of monitoring views by the driver to monitor the driving action in the active driving situation, and/or the target viewing sequence can include a time interval between each two views of the target viewing sequence. This enables the target viewing sequence to be specified precisely.

According to another advantageous design, the actual viewing sequence can be a sequence of monitoring views of the driver for monitoring the driving events during an active driving situation, and/or the actual viewing sequence may include a time interval between each two views of the target viewing sequence during the active driving situation. This enables the actual viewing sequence to be specified precisely.

According to a further, advantageous design, the method may also include a determination of the state of the driver as inattentive if the change in the actual viewing sequence from the target viewing sequence indicates a change and/or an omission of a view of the target viewing sequence. This can be used to efficiently detect that the driver of the vehicle is inattentive.

According to a further, advantageous design, the method may also include a determination of the state of the driver as tired and inattentive if the change in the actual viewing sequence from the target viewing sequence indicates that a time interval between at least two views of the actual viewing sequence exceeds a predetermined threshold value, and the change in the actual viewing sequence from the target viewing sequence indicates a change and/or omission of a view of the target viewing sequence. This can be used to efficiently detect that the driver of the vehicle is inattentive and tired.

A further aspect is characterized by a computer-readable medium for monitoring a state of a driver of a vehicle by means of a camera in an interior of the vehicle, wherein the computer-readable medium contains instructions which, when executed on a control unit or a computer, carry out the method described above.

Another aspect is by a system for characterized monitoring a state of a driver of a vehicle by means of a camera in an interior of the vehicle, wherein the system is designed to carry out the method described above.

Yet another aspect is a vehicle, containing the system described above for monitoring a state of a driver of a vehicle by means of a camera in an interior of the vehicle.

Further features can be seen from the claims, the figures and the description of the figures. All the features and combinations of features mentioned above in the description as well as the features and combinations of features mentioned below in the description of figures and/or shown in the figures alone can be used not only in the respective specified combination, but also in other combinations or else on their own.

### BRIEF DESCRIPTION OF THE DRAWING FIGURE

FIG. 1 shows an exemplary method for monitoring a state of a driver of a vehicle by means of a camera in an interior of the vehicle.

### DETAILED DESCRIPTION

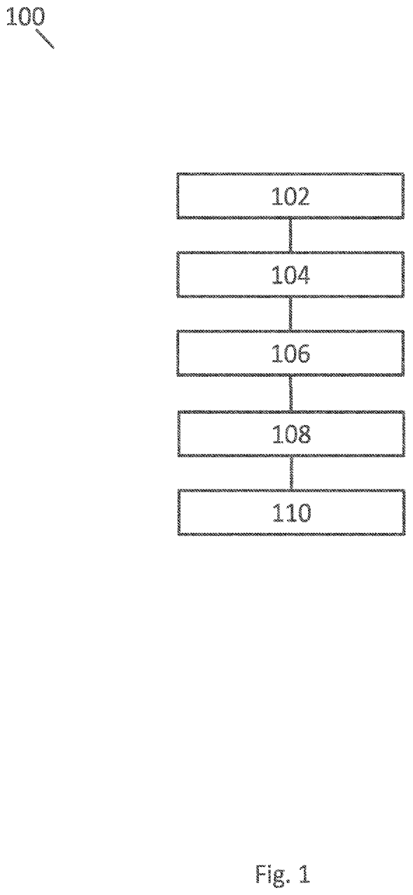

In detail, FIG. 1 shows an exemplary method 100 for monitoring a state of a driver of a vehicle by means of a camera in an interior of the vehicle. The method 100 can determine the viewing behavior of the driver of the vehicle during an active driving situation with the vehicle by means of the camera in the interior of the vehicle 102. The method 100 can continuously monitor the driver of the vehicle by means of the camera. The camera can observe a viewing direction and an eye condition of the driver. Over a longer period of time, for example 5, 10, 20, 30, 40, . . . minutes, the driver's viewing behavior can be observed by the camera during the active driving situation. During this period, it is possible to detect regularities of the viewing behavior and to measure the time between views of a sequence of views and a duration of views of the driver.

The method 102 can determine a target viewing sequence of the active driving situation 104. In detail, the target viewing sequence can correspond to a regularity of views in the driver's viewing behavior over a longer period of time, which shows the driver in an awake and attentive state in the active driving situation. The target viewing sequence may include a regular sequence of monitoring views by the driver. For example, the target viewing sequence may include a regular sequence of monitoring interior mirror, in one or more exterior views in an mirrors, of a speed indicator, through a windscreen, a shoulder view, and/or through one or more side windows of the vehicle. The target viewing sequence can be determined depending on a planned navigation route. The planned navigation route may include, for example, turns that the driver must perform in order to drive along the planned navigation route. A planned turning maneuver of the planned navigation route can be used to determine a target viewing sequence of the driver before the active driving situation occurs, i.e. before the turning maneuver occurs. In general, the method 100 can predict the target viewing sequence depending on the planned navigation route. In addition, or alternatively, setting a direction indicator by the driver can be used to determine the target viewing sequence.

Furthermore, the method 100 can determine 106 an actual viewing sequence during the active driving situation depending on the viewing behavior of the driver of the vehicle. Furthermore, the method 100 can determine 108 a change in the actual viewing sequence from the target viewing sequence during the active driving situation. For example, changing the actual viewing sequence from the target viewing sequence may include a change in views in the actual viewing sequence compared to the target viewing sequence, and/or a temporal change in views and/or in spacings between views of the actual viewing sequence from the target viewing sequence. The change can be used as an indicator to infer a state of tiredness and/or inattentiveness on the part of the driver.

Finally, the method 100 can determine 110 the state of the driver depending on the determined change in the actual viewing sequence from the target viewing sequence during the active driving situation. The method 100 can determine the state of the driver as tired if the change in the actual viewing sequence from the target viewing sequence indicates that a time interval between at least two views of the actual viewing sequence exceeds a predetermined threshold value. can The method 100 determine the state of the driver as inattentive if the change in the actual viewing sequence from the target viewing sequence indicates a change and/or omission of a view of the target viewing sequence. And the method 100 can determine the state of the driver as tired and inattentive if the change in the actual viewing sequence from the target viewing sequence indicates that a time interval between at least two views of the actual viewing sequence exceeds a predetermined threshold value, and the change in the actual viewing sequence from the target viewing sequence indicates a change and/or omission of a view of the target viewing sequence. Advantageously, the method can efficiently determine the state of the driver as tired and/or inattentive and thus efficiently monitor the state of the driver.

### LIST OF REFERENCE SIGNS

100 Method
102 Determination of the viewing behavior of a driver of the vehicle during an active driving situation
104 Determination of a target viewing sequence of the active driving situation
106 Determination of an actual viewing sequence during the active driving situation
108 Determination of a change in the actual viewing sequence from the target viewing sequence
110 Determination of the state of the driver as tired

1.-11. (canceled)

12. A method of monitoring a state of a driver of a vehicle using a camera in the interior of the vehicle, the method comprising:
determining a viewing behavior of a driver of the vehicle during an active driving situation with the vehicle using the camera in the interior of the vehicle;
determining a target viewing sequence of the active driving situation;
determining an actual viewing sequence during the active driving situation depending on the viewing behavior of the driver of the vehicle;
determining a change in the actual viewing sequence from the target viewing sequence during the active driving situation; and
determining the state of the driver as tired if the change in the actual viewing sequence from the target viewing sequence indicates that a time interval between at least two views of the actual viewing sequence exceeds a predetermined threshold value.

13. The method as claimed in claim 12, wherein the camera is integrated into the interior of the vehicle and enables an unrestricted view of a driver.

14. The method as claimed in claim 13, wherein the camera is integrated into an interior mirror of the vehicle.

15. The method as claimed in claim 12, wherein the camera is integrated into an interior mirror of the vehicle.

16. The method as claimed in claim 12, wherein the target viewing sequence of the active driving situation is determined depending on at least one of the group consisting of:
a navigation task along a navigation route of the vehicle;
an operating interaction of the driver with a driving-relevant operating component of the vehicle;
a driving event; and
a model of the surroundings of the vehicle.

17. The method as claimed in claim 16, wherein the target viewing sequence of the active driving situation is determined depending on an operating interaction of the driver with a driving-relevant operating component of the vehicle.

18. The method as claimed in claim 16, wherein the target viewing sequence of the active driving situation is determined depending on a model of the surroundings of the vehicle.

19. The method as claimed in claim 12, wherein:
the target viewing sequence is a driver-specific target viewing sequence of the active driving situation; and
the driver-specific target viewing sequence is preferably learned within a predetermined time interval using a historical viewing behavior of the driver of the vehicle in the active driving situation.

20. The method as claimed in claim 12, wherein the target viewing sequence includes a sequence of monitoring views of the driver for monitoring the driving events in the active driving situation.

21. The method as claimed in claim 20, wherein the target viewing sequence includes a time interval between each two views of the target viewing sequence.

22. The method as claimed in claim 12, wherein the actual viewing sequence includes at least one of the group consisting of:
a sequence of monitoring views of the driver for monitoring the driving events during the active driving situation; and
a time interval between each two views of the target viewing sequence during the active driving situation.

23. The method as claimed in claim 12, further comprising:
determining the state of the driver as inattentive if the change in the actual viewing sequence from the target viewing sequence indicates a change or an omission of a view of the target viewing sequence.

24. The method as claimed in claim 12, further comprising:
determining the state of the driver as tired and inattentive if the change in the actual viewing sequence from the target viewing sequence indicates that a time interval between at least two views of the actual viewing sequence exceeds a predetermined threshold value, and the change in the actual viewing sequence from the target viewing sequence indicates a change or an omission of a view of the target viewing sequence.

25. A computer-readable medium for monitoring a state of a driver of a vehicle using a camera in an interior of the vehicle, wherein the computer-readable medium contains instructions which, when executed on a control unit or a computer, carry out the method as claimed in claim 12.

26. A system for monitoring a state of a driver of a vehicle using a camera in an interior of the vehicle, wherein the system is designed to carry out the method as claimed in claim 12.

27. A vehicle containing the system for monitoring the state of the driver of the vehicle using the camera in an interior of the vehicle as claimed in claim 26.

28. A system for monitoring a state of a driver of a vehicle, comprising:
at least a first camera configured to obtain information representative of a viewing behavior of a driver of the vehicle during an active driving situation with the vehicle using the camera in the interior of the vehicle;
a control unit configured to,
determine a target viewing sequence of the active driving situation;
determine an actual viewing sequence during the active driving situation depending on the information representative of the viewing behavior of the driver of the vehicle;
determine a change in the actual viewing sequence from the target viewing sequence during the active driving situation; and
determine the state of the driver as tired if the change in the actual viewing sequence from the target viewing sequence indicates that a time interval between at least two views of the actual viewing sequence exceeds a predetermined threshold value.

29. The method as claimed in claim 28, wherein the camera is integrated into the interior of the vehicle and enables an unrestricted view of a driver.

30. The method as claimed in claim 28, wherein the camera is integrated into an interior mirror of the vehicle.

31. The method as claimed in claim 28, wherein:
the target viewing sequence is a driver-specific target viewing sequence of the active driving situation; and
the driver-specific target viewing sequence is preferably learned within a predetermined time interval using a historical viewing behavior of the driver of the vehicle in the active driving situation.
